(19) United States
(12) Patent Application Publication
(10) Pub. No.: US 2005/0190745 A1
(43) Pub. Date: Sep. 1, 2005

(54) Method and apparatus that adapts coding schemes to data resource limits of a mobile station coupled to a peripheral device

(76) Inventors: Gary E. Western, Round Lake, IL (US); Sriram S. Chaturvedi, Palatine, IL (US); Parthasarathy Subramanian, Wheeling, IL (US)

Correspondence Address: MOTOROLA, INC., 1303 EAST ALGONQUIN ROAD, IL01/3RD, SCHAUMBURG, IL, 60196, US

(21) Appl. No.: 10/788,630

(22) Filed: Feb. 27, 2004

(51) Int. Cl. H04L 12/28

(52) U.S. Cl. 370/352

(57) ABSTRACT

A method (800) and apparatus (252, 205) are for adapting coding schemes used on a downlink channel of a wireless packet data communication system (100) to data resource limits of a mobile station (180, 270) coupled to a peripheral device (185, 280). The method includes transmitting (815) a set of data on the downlink channel to the mobile station using a current combination of coding schemes that have a current data rate, monitoring (820) whether a data transfer rate of the peripheral device has been exceeded, and establishing (840) an optimal combination of coding schemes to be the current combination of coding schemes when a search criterion that is based on whether the data transfer rate of the peripheral device has been exceeded is met (826). The monitoring includes determining whether intervals of acknowledgements transmitted from the mobile station on the uplink channel in response to the set of data meet (910) uniformity criteria.

### FIELD OF THE INVENTION

This invention is generally in the field of radio communication systems and more specifically in the field of packet radio communication system protocols.

### BACKGROUND

In wireless networks employing General Packet Radio Service (GPRS), a coding scheme for data message transmissions is selected by rules embedded in a fixed network and in a mobile station that are designed to result in the highest data throughput with the fewest possible retransmissions. GPRS is an extension of circuit-switched networks and data transmission services that uses packet radio transmissions to carry data messages using protocols such as Internet Protocol (IP) or X.25 information from mobiles to the network and visa versa, in data blocks, or packets. GPRS is an extension to the circuit-switched Global System for Mobile communications (GSM), having four different coding schemes with effective data rates of 9.05, 13.4, 15.6 and 21.4 kilobits per second (code rates ½, ⅔, ¾ and 1) when using one of the eight time slots available within a TDMA frame.

Some GPRS-enabled fixed networks can transmit data to a mobile station, such as a cell phone, an Internet-enabled mobile phone or a personal digital assistant, using a selected one of the four coding schemes. However, the mobile unit may have resource limitations that prevent it from accepting data at some of the higher coding schemes, such as an effective data rate that is less than the maximum data rate that the mobile unit supports. Such a resource limitation arises when the mobile unit is coupled to a peripheral device using an effective downlink data transfer rate that is less than the maximum downlink radio channel data rate that the mobile unit can support. For example a mobile unit may act as a radio frequency modem for a personal computer (the peripheral, for the purposes of this document) that is coupled to the mobile unit by a serial link that has an effective data rate less than the effective data rate of the RF downlink. Another inherent resource limitation is a finite depth of a buffer memory of the mobile unit used to buffer data being sent to the peripheral device through the mobile unit. The fixed network can send data to the mobile station at a data rate greater than the effective downlink data rate determined by the link between the mobile unit and the peripheral, and the mobile unit can accept and acknowledge that data, until the buffer is full. At that time, the mobile unit has to being rejecting some of the downlink data packets. With the move toward third-generation network standards, there are even more possible problems of these types with high-performance networks that use a wider variety of coding schemes.

Current GPRS fixed networks typically use dynamic link adaptation methods that monitor the quality of packet transfers and select one of the four presently defined channel coding schemes (also referred to herein simply as “coding schemes”) based on changing radio conditions. As technologies and protocols emerge and evolve for wireless data transmissions, additional coding schemes will become available. For example, GSM networks incorporating Enhanced Data for Global Evolution (EDGE) with packet-switched enhancements for GPRS (also called Enhanced General Packet Radio Service) have nine additional coding schemes for increased performance. Other wireless network technologies such as GSM/EDGE Radio Access Network (GERAN) and Universal Mobile Telecommunications System (UMTS) provide enhanced coding schemes, requiring network algorithms that can determine the coding scheme adaptability of the mobile station and direct coding scheme commands to the mobile station based on the adaptability. When the protocol or implementation of the radio communication system does not allow the reporting of the above mentioned resource limitations of mobile stations, downlink coding scheme determination methods in current use result in sub-optimal data throughput due to re-transmissions that occur when the effective downlink data rate of the selected coding scheme exceeds the effective data transfer rate between the mobile unit and a peripheral device.

### BRIEF DESCRIPTION OF THE DRAWINGS

The present invention is illustrated by way of example and not limitation in the accompanying figures, in which like references indicate similar elements, and in which:

FIG. 1 is a schematic diagram of one embodiment of a system for determining coding scheme adaptation capability of a mobile station, in accordance with some embodiments of the present invention;

FIG. 2 is a block diagram of one embodiment of a system for determining coding scheme adaptation capability of a mobile station, in accordance with some embodiments of the present invention;

FIGS. 3-6 are illustrations of four coding schemes used for GPRS, in accordance with some embodiments of the present invention;

FIG. 7 is a time plot that shows uplink (TCP) acknowledgements when two coding schemes are used in a GPRS system, in accordance with some embodiments of the present invention;

FIG. 8 is a flow chart that shows a method of adapting coding schemes used on a downlink channel of a wireless packet data communication system, in accordance with some embodiments of the present invention;

FIG. 9 is a flow chart shows one method of monitoring whether the data transfer rate of the peripheral device is exceeded, in accordance with some embodiments of the present invention;

FIGS. 10 and 11 are flow charts that show details of the steps described with reference to FIG. 9, in accordance with some embodiments of the present invention;

FIG. 12 is a timing diagram that shows one example of the use of a binary search technique described with reference to FIG. 11;

FIG. 13 is a flow chart that shows more detail of a step of determining a buffer depth of a buffer memory of the mobile, in accordance with some embodiments of the present invention;

FIG. 14 is a time plot that shows data packets as an initial data message having a long set of data is being sent to a mobile station, in accordance with some embodiments of the present invention; and

FIG. 15 is a time plot that shows data packets of another data message having a long set of data, in accordance with some embodiments of the present invention.

Should FIG. 16 have an entry here?

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE DRAWINGS

The present invention provides a method and apparatus that adapt coding schemes to data resource limits of a mobile station coupled to a peripheral device, thereby maximizing downlink data throughput to mobile stations connected to a radio communication network that have a data transfer rate between the mobile station and the peripheral that is lower than the data rate of the highest coding scheme that is supported by the mobile station.

Before describing in detail the particular method and apparatus in accordance with the present invention, it should be observed that the present invention resides primarily in combinations of method steps and apparatus components related to base station controllers for radio communication systems. Accordingly, the apparatus components and method steps have been represented where appropriate by conventional symbols in the drawings, showing only those specific details that are pertinent to understanding the present invention so as not to obscure the disclosure with details that will be readily apparent to those of ordinary skill in the art having the benefit of the description herein.

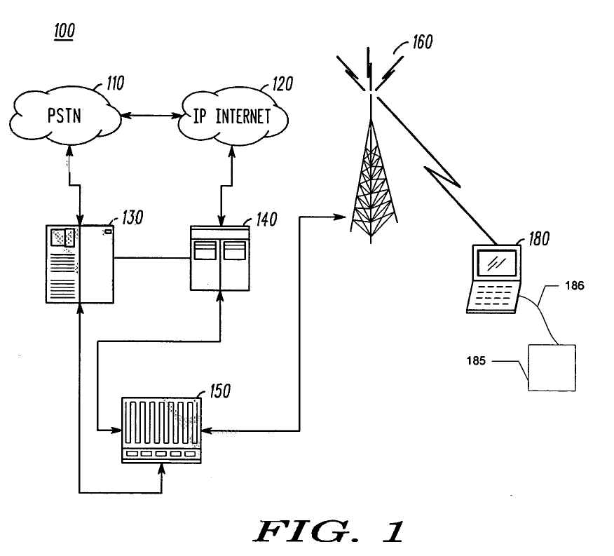

FIG. 1 shows a block diagram of one embodiment of a communication system 100, in accordance with some embodiments of the present invention. The communication system 100 includes one or more public-switched telephone networks (PSTN) 110, an Internet 120, one or more mobile switching centers (MSC) 130, one or more general packet radio service support nodes (GSN) 140, one or more base site controller and packet controller units (BSC/PCU) 150, one or more radio tower or base transceiver stations (BTS) 160, and one or more wireless mobile stations (MS) 180 such as a Internet-enabled cellular phone, a personal digital assistant or a laptop computer with wireless networking capabilities. Some of the wireless mobile stations 180 may be coupled to a peripheral 185 by a link 186, which is illustrated in FIG. 1 as a wired link, but could alternatively be a wireless link.

An exemplary network technology that may be used for network operations is Global System for Mobile (GSM) communications, a digital cellular standard used throughout the world. GSM data services include circuit-switched voice services, circuit-switched data, short message services (SMS), 2.5 G and third-generation (3G) technologies that expand data-packet technologies and new multimedia types of wireless service. GSM uses three major frequency bands, including blocks of radio spectrum within the 900-, 1800-, and 1900-MHz bands. The 900- and 1800-MHz bands are the principal bands used in Europe and Asia, and the 1900-MHz band is used in North America.

With wireless networks employing General Packet Radio Service (GPRS), a mobile station is commanded to transmit data blocks at the optimal coding scheme that the network determines will result in the highest data throughput with the fewest possible retransmissions. For example, GPRS may offer transmissions via a GSM network within a range of 9.6 kilobits to 115 kilobits and allow users to make telephone calls and transmit data at the same time, the latter using an IP data transmission protocol.

Another embodiment of the wireless network may include Enhanced Data for Global Evolution (EDGE), which is moving toward wideband code division multiple access (WCDMA). EDGE may be used as a packet-switched enhancement for general packet radio service (GPRS), known as enhanced GPRS or EGPRS, and as a circuit-switched data enhancement called enhanced circuit-switched data (ECSD).

Public-switched telephone network (PSTN) 110 is a land-based telephone network. PSTN 110 may comprise one or more switched lines over one or a combination of wire, fiber, or wireless links. PSTN 110 is typically connected to Internet 120 and MSC 130.

Internet 120 is a public data communication network, which may comprise one or more electronic, optical or wireless communication paths with associated hardware and software to connect PSTN 110 with one or more wireless data devices 180.

Mobile switching center 130 may receive signals from and send signals to wireless data device 180 via a general packet radio service support node (GSN) 140, base site controller and packet controller units (BSC/PCU) 150, and BTS 160. MSC 130 may contain suitable hardware and software for ensuring that transmissions between wireless data device 180 and BTS 160 are accurate and reliable. Accurate and reliable transmission of data packets (blocks) may require that certain data packets be retransmitted, or encoded in a manner such that the data packets are decoded at the receiver without requiring an additional transmission of the data packets. MSC 130 may communicate with PSTN 110.

Mobile switching center 130 may be connected directly to Internet 120 via GSN 140 without requiring PSTN 110 as an intermediary. GSN 140 works with general packet radio service (GPRS), a packet-mode technique to transfer high-speed and low-speed data and to signal in an efficient manner over GSM radio networks. GPRS may employ GSN 140 to keep track of the location of wireless data device 180 and to perform security functions and access control. GSN 140, which is at the same hierarchical level as MSC 130, may be connected to the system of BTS 160 with frame relay. GSN 140 provides interworking with external packet-switched networks such as Internet 120, and is connected with GSN 140 via the IP-based GPRS backbone network. GSN 140 can help MSC 130 with more efficient coordination of GPRS and non-GPRS services and functionality.

Base site controller and packet controller units (BSC/PCU) 150 may be connected to MSC 130, GSN 140 and BTS 160. The BSC/PCU 150 helps control BTS 160 in call set-up functions, coding schemes to use and use of radio channels, and various maintenance tasks.

Base transceiver station (BTS) 160 contains suitable electronic equipment for transmitting and receiving radio frequency signals. BTS 160 may transmit and receive radio signals and more particularly, digitally encoded signals from wireless data device 180. Communications between BTS 160 and wireless data device 180 includes the transmission of data packets, which may be digitally encoded. The data packets may be intended for the peripheral 185 coupled to a wireless data device 180.

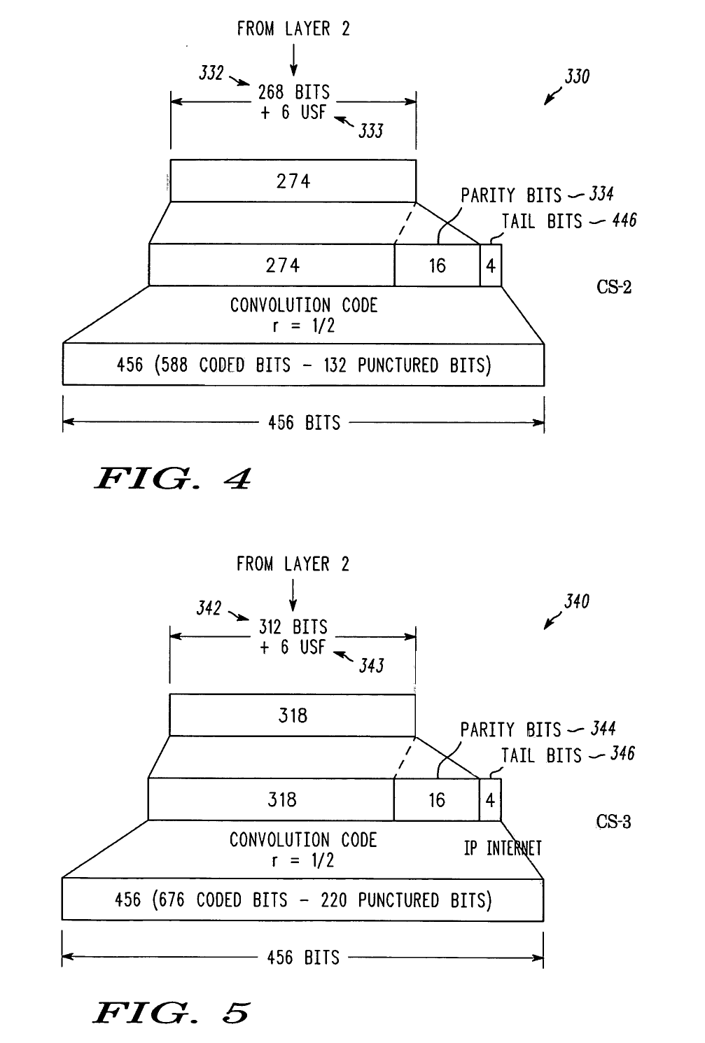

The data packets may be digitally encoded using a coding scheme (codes). The term scheme and code may be used interchangeably as appreciated by those skilled in the art. These schemes may be used in a variety of combinations with one or more received data packets. The transmission of data packets may use one or more modulation schemes, such as 16-QAM (quadrature amplitude modulation) or 8-PSK (phase shift keying). The modulation schemes and encoding schemes may be adaptively chosen based on factors such as requisite bit error rates (BER) or channel quality attributes. In accordance with the present invention, coding schemes are characterized in an ordinal relationship to each other, so that there are higher and lower coding schemes, with the higher coding schemes generally providing higher effective data throughput (i.e., the data rate not including error protection bits), and correspondingly requiring better environmental conditions to achieve sufficiently error free effective data throughput. Conversely, lower coding schemes generally employ either more redundant information or use slower modulation techniques to achieve effective data throughput that is similarly error free. Also, changing the coding scheme from a lower coding scheme to a higher coding scheme is referred to herein as raising the coding scheme, and conversely, a coding scheme can be lowered to a lower coding scheme. A successful transmission of multiple data packets comprising a data message may involve at least one additional transmission attempt (retransmission) of specific data packets whose contents were unsuccessfully decoded at the receiver. The retransmission may comprise a repeated transmission of the data packet that was corrupted in the channel. The retransmission may be sent at a lower coding scheme to improve the reliability of the data. The retransmission may also be sent using the same coding scheme, such as a repeated transmission. The retransmission may be sent at a higher coding scheme for faster data throughput. The coding scheme selection may be determined, for example, with feedback from wireless data device 180, by a data scheme selected by the packet control unit (PCU) portion of the BSC/PCU 150 and communicated to the BTS 160. A detailed description of some of the rules for selecting a coding scheme is given below with reference to FIGS. 7-9.

Wireless data device 180, which may be a cellular phone, a laptop computer, a wireless modem coupled to a laptop computer or other peripheral device, a PDA or other wireless device, is equipped with suitable hardware and software for receiving and transmitting digital transmissions. Wireless data device 180 typically transmits or receives data in a prescribed band of frequencies nominally at 900 MHz, 1900 MHz, or any other suitable band of frequencies prescribed for wireless communication. Wireless data device 180 may be carried by a human user, installed on mobile equipment, used in a fixed location such as on a desk or used in any other application where wireless communication services are desired.

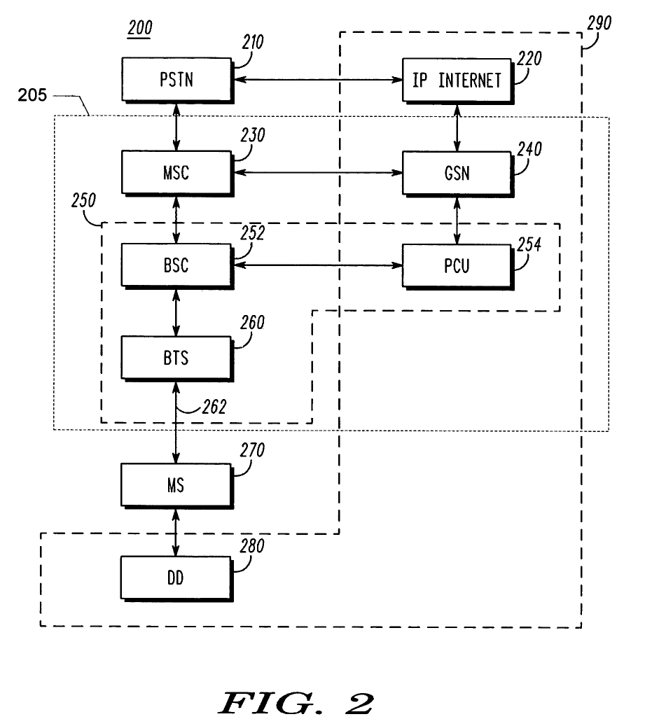

FIG. 2 is a block diagram of one embodiment of a communication system 200, in accordance with the present invention. Components of communication system 200 include a public-switched telephone network (PSTN) 210, a mobile switching center (MSC) 230, base station subsystem (BSS) 250, and a packet radio network 290.

Public switch telephone network (PSTN) 210, a land-based telephone network, is coupled to the MSC 230. The packet radio network 290 comprises an Internet-protocol network 220 is coupled to, one or more GPRS support nodes (GSN) 240, which are coupled to one or more packet controller units (PCU) 254. One or more wireless data devices 280 form a portion of the packet radio network 290.

GPRS support nodes (GSN) 240, as payload-carrying and control devices, help the network to switch packet data, routing packets to and from the geographical area of packet radio-specific network 290 and interfacing with Internet-protocol network 220. GSN 240 may be physically separate from the circuit-switched part of a cellular system core network, as shown in FIG.2, where it is coupled to the MSC 230, or may be integrated with the MSC 230. GSN 240 contains GPRS backbone network protocol (IP) routing functionality, and can be interconnected with IP routers.

Packet Controller Unit (PCU) 254 serves as an interface between BSS 250 and packet radio-specific network 290, performing radio functions and general packet radio service (GPRS) network functions. In addition to PCU 254, base site (or base station) controller (BSC) 252 and base transceiver station (BTS) 260 are components of BSS 250. BSC 252 controls radio signals of multiple cell sites, thus reducing the load on MSC 230. BSC 252 also performs radio signal management functions for BTS 260, managing functions such as frequency assignment and handoff. BTS 260, which may be equipped with antenna and radio equipment, is the central radio transmitter/receiver that maintains communications with mobile station (MS) 270 within its cell site or given range.

Mobile station 270 consists of mobile equipment such as a cellular phone and is used to communicate with the GSM network. Mobile station 270 may be coupled to or physically integrated with the data device (DD) 280, which may be a device such as a mobile personal digital assistant (PDA) or a laptop computer. Coupling between the MS 270 and the data device 280 can be, for instance, a wired link such as an RS-232 link, or could be by a wireless local area network link such as an infrared link, either of which may have a 56 Kbps limitation, or a link such as those specified in IEEE 802.11. Such links could be used whether or not the MS 270 and DD 280 are physically integrated, but are more likely to be used only when the MS 270 and DD 280 are not physically integrated. Mobile station 270 couples to base transceiver station 260 via air interface 262, which is a preferably standard signaling system of a standard wireless network technology, preferably conforming to one of the GSM standards. When the MS 270 and DD 280 are physically integrated, then the functions of both may be provided by one processor, or the functions may be provided by two processors coupled by links that can couple data at speeds substantially higher than those that are possible using the air interface 262. For the purposes of this document, whenever the MS 270 and DD 280 are coupled by a link that has a lower data rate than the highest data rate of the air interface, then DD 280 is referred to hereinafter as a peripheral device to the MS 270, whether or not the DD 280 is physically integrated with the MS 270. The average data rate that can be achieved between the MS 270 and the peripheral device 280 is hereinafter termed the data transfer rate.

The portion of the communication network comprising the MSC 230, the GSN 240 and the BSS 250 may be called the fixed network.

Other network topologies besides the network architecture described above are possible without departing from the essential characteristics of the present invention. Additional components to separate various functions of a piece of equipment or module may be included with departing from the nature of the present invention.

As previously mentioned, the PCU 254 manages, allocates, and schedules the packet data resources necessary to allow uplink and downlink packet data transmission between the BTS 260 and the MS 270 with its associated peripheral device 280. Specifically, a packet resource manager (not shown) within the PCU 254 receives data, determines how to best “package” the data, and then instructs (via control instructions) the BTS 260 to package the data accordingly. Once received by the MS 270 from the BTS 260, the data packages are “unpackaged” and reassembled, thereby completing the transmission of the data to the MS 270, which then may transfer the unpackaged data to the peripheral device 280, depending on the nature of the contents of the unpackaged data

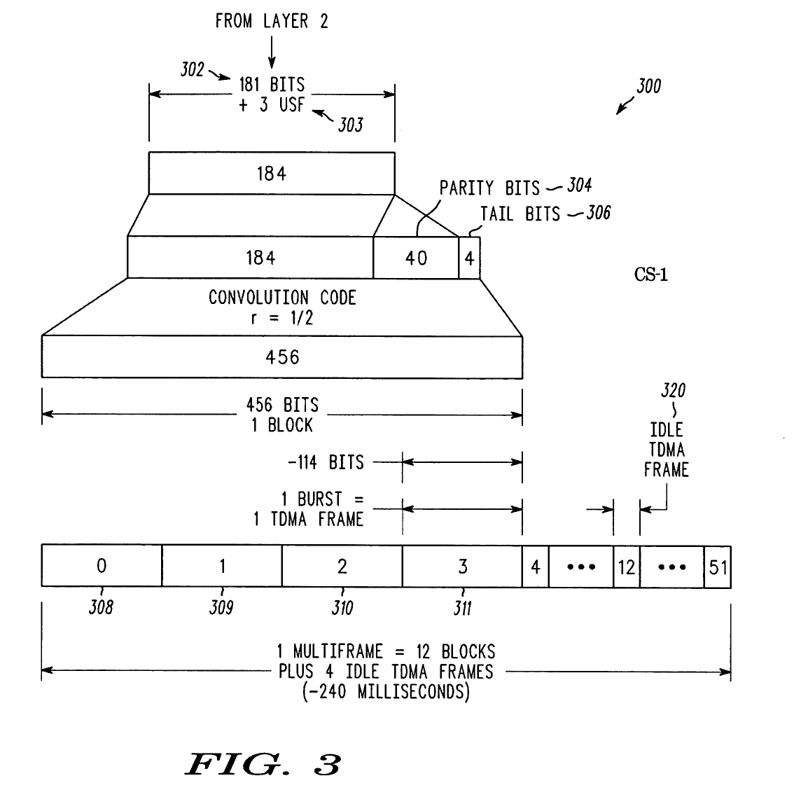

For example, layer 2 user data bits received by the PCU 254 from the IP internet 220 via the GSN 240 (resulting from a particular software application) are in the form of Logic Link Control (LLCs) frames. Upon receipt, the PCU 254 splits each of the LLCs into segments of bits and inserts additional bits (e.g., polling bits, data encoding instructions, etc.). The resulting blocks of bits, herein referred to as “segmented blocks,” are forwarded to the BTS 260 for transmission as a downlink data message. Based on the data encoding instructions embedded in the segmented blocks by the PCU 254, the segmented blocks are encoded, or modulated, by the BTS 260 using the GPRS coding schemes, and the downlink data message is transmitted to the MS 270 as GPRS radio blocks. Similarly, a data message can be generated by the mobile data device 280 and transmitted from the MS 270 using the GPRS coding schemes. Current GPRS coding schemes selectable by the PCU 254 include Coding Scheme 1 (CS-1), CS-2, CS-3, or CS-4 (see, FIGS. 3-6) and Modulated Coding Scheme 1 (MCS-1), MCS-2, MCS-3, MCS-4, MCS-5, MCS-6, MCS-7, MCS-8, and MCS-9.

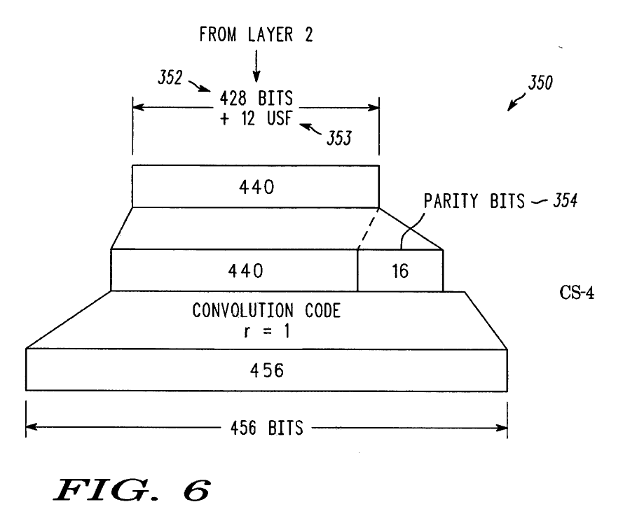

The particular GPRS coding scheme selected by the PCU 254 and MS 270 is based on whether the data is control data requiring maximum protection for transmitted bits, or maximum data integrity, requiring CS-1 coding, or whether the data is user data. If the data is user data, varying coding schemes (e.g., CS-1 through CS-4) are selected by the PCU 254, generally based on channel quality factors and knowledge of the coding scheme capabilities of the MS 270, as described in more detail with reference to FIGS. 7 and 8 below.

The BTS 260 and the MS 270 encode the data into the GPRS radio blocks suitable for transmission over the Packet Data Traffic Channel between the BTS 260 and the MS 270. For ease of discussion, the GPRS radio blocks carrying encoded data may be referred to herein as “GPRS data blocks”.

FIG. 3 is an illustration of coding scheme 1 (CS-1) 300 for maintaining maximum data integrity of GPRS radio blocks in a GPRS packet data transmission channel (PDTCH), in accordance with the preferred and alternative embodiments of the present invention. Referring to FIG. 3, for the CS-1 300, 181 Layer 2 bits resulting from applications (e.g., email, web browser, paging, etc.) as well additional information bits inserted by the PCU 254 are forwarded to the BTS 260 as a portion of a downlink data message (or possibly as a complete, short data message). (Of course, as is known, thousands of bits of layer 2 data may be received by the PCU 254 as a data message from a particular application). Based at least partially on the number of bits received and the information bits inserted by the PCU 254, a predetermined number of uplink state flag (USF) bits 303 are added to the 181 Layer 2 bits 302 by the BTS 260. The USF bits 303 are configured to notify a particular MS 270 that it has uplink transmission rights. Similarly, parity bits 304 and tail bits 306 are added to the 181 Layer 2 bits for error correction, herein referred to as a “block check sequence” (BCS). The addition of the USF bits 303, the parity bits 304 and the tail bits 306 to the Layer 2 bits 302 results in 228 bits to be encoded. To maximize data integrity during transmission, each of the 228 bits of data is copied, resulting in 228 original bits and 228 copied bits for a total of 456 bits (i.e., a ½ code rate) to be transmitted from the BTS 260 to the MS 270. As is known in the art, each group of 456 bits may be referred to a one GPRS data block. The 456 bits are distributed among four “bursts” containing approximately 114 bits/burst (i.e., one TDMA frame) shown in FIG. 3 as bursts 308, 309, 310, 311. Thus, two copies of each the original 181 Layer 2 bits 302 are transmitted from the BTS 260, thereby increasing the odds that each of the original 181 Layer 2 bits 302 are received by the MS 270. Typically, the four bursts 308-311 are transmitted with forty-four additional bursts 312 (representing eleven additional GPRS radio blocks), and four idle bursts (i.e., TDMA frames) in a “multiframe” configuration. As shown in FIGS. 3-6, a multiframe 320 is transmitted in approximately 240 milliseconds. Upon receipt of the multiframe(s) 320, using well-known methods, bits inserted in the bursts by the BTS 260 at the direction of the PCU 254 are used by the MS 270 to decode and reconstruct the data is a form suitable for receipt by an end user.

Of course, as will be appreciated by those of ordinary skill in the art, the “cost” of using the CS-1 scheme is high in terms of bandwidth resources; less than one data message bit is recovered for every 2 bits transmitted. The GPRS PDTCH coding schemes CH-2, CH-3, and CH-4 are constructed to more efficiently utilize bandwidth resources, depending on the quality or robustness of the communication channel 124. More particularly, CH-2 and CH-3 utilizes controlled bit reduction, herein referred to as “bit puncturing” to reduce the amount of copied data bits transmitted. Moreover, CH-4 adds only USF and parity bits to the original layer 2 bits prior to transmission to the MS 270; no copied bits are transmitted.

For example, FIG. 4 is an illustration of the coding scheme 2 (CS-2) 330 where approximately ⅓ of the copied bits are punctured. Referring to FIG. 4, for CS-2, 268 Layer 2 bits 332 are transmitted from the PCU 254 to the BTS 260. Similar to CS-1 300, 6 USF bits 333, 16 parity bits 334 and 4 tail bits 336 are added to the 268 Layer 2 bits 332. The addition of the USF bits 333, the parity bits 334 and the tail bits 336 to the Layer 2 bits 302 results in 294 bits to be encoded. Each of the 294 bits of data is copied resulting in 294 original bits and 294 copied bits for a total of 588 bits. Of the 588 bits, however, only 456 bits are transmitted (i.e., a ⅔ code rate) from the BTS 260 to the MS 270. The remaining 132 are selectively discarded based on known statistics. Thus, the original 268 Layer 2 bits 332 and approximately ⅔ of the copied 268 layer 2 bits are transmitted from the BTS 260 to the MS 270.

FIG. 5 is an illustration of the coding scheme 3 (CS-3) 340 where approximately ⅔ of the copied bits are punctured. Referring to FIG. 5, for CS-3, 312 Layer 2 bits 332 are transmitted from the PCU 254 to the BTS 260. Like CS-2 330, 6 USF bits 343, 16 parity bits 344 and 4 tail bits 346 are added to the 312 Layer 2 bits 342. The addition of the USF bits 333, the parity bits 334 and the tail bits 336 to the Layer 2 bits 302 results in 338 bits to be encoded. Each of the 338 bits of data is copied resulting in 338 original bits and 338 copied bits for a total of 676 bits. Of the 676 bits, however, only 456 bits are transmitted (i.e., a ¾ code rate) from the BTS 260 to the MS 270. The remaining 220 bits are selectively discarded based on known statistics. Thus, the original 312 Layer 2 bits 342 and approximately ⅓ of the copied 312 layer 2 bits are transmitted from the BTS 260 to the MS 270.

FIG. 6 is an illustration of a coding scheme 4 (CS-4) 350 where no copied bits are generated and no bits are punctured. Referring to FIG. 6, for CS-4, 428 Layer 2 bits 352 are transmitted from the PCU 254 to the BTS 260. Unlike coding schemes CS-1, CS-2, and CS-3, only USF bits 353 and parity bits 354 are added to the Layer 2 bits. The addition of 12 USF bits 353 and 16 parity bits 354 to the 428 Layer 2 bits 352 results in exactly 456 bits. Thus, only the original 428 Layer 2 bits 352 are transmitted from the BTS 260 to the MS 270.

When the MS 270 transmits a data burst to the BTS 260 in an uplink data message using one of the coding schemes CS-1, CS-2, CS-3, or CS-4, the data message bits and error control bits are arranged similarly to those in downlink data message bursts. However, the control bits that are included in an uplink burst have meanings different from those of the USF bits in a downlink burst and may be different in number than the USF bits of a downlink burst.

The CS-4 350 provides the most efficient utilization of bandwidth resources and is therefore the coding scheme of choice when channel conditions of the communication channel 124 permits (i.e., optimum channel conditions) and the equipment (BTS 260 and MS 270) is capable of such encoding scheme. Conversely, the CS-1 300 provides the most reliable scheme to ensure data integrity of the GPRS radio blocks received or transmitted by the MS-1 and is therefore the coding scheme of choice when the communication channel 124 is adversely affected or when transmission of a control information message is required. The CS-2 330 and the CS-3 340 provide intermediate coding schemes.

As will be appreciated by those of ordinary skill in the art, coding schemes for GPRS PDTCH can be achieved using a number of coding schemes, for example modulation and coding schemes, MCS-1 to MCS-9 suitable for use with enhanced GPRS.

GSM specifications include requirements that mobile stations 270 that are designed for use in GPRS systems be capable of receiving and transmitting the four defined coding schemes CS-1, CS-2, CS-3, and CS-4. Particularly in instances in which the MS 270 can operate using CS-3 or CS-4, the data device 280 may operate as a peripheral device—that is, the data transfer rate to the data device 280 may be slower than the downlink data rate from the base transmitter station (BTS) 260 to the MS 270. In systems that use GPRS, there is no standard for conveying to the Base Station Subsystem 250 or packet radio network 290 the data transfer rate from the MS 270 to the DD 280. As a result, the MS 270 may attempt to send a long set of data to the MS 270 that is intended for the DD 280 at a data rate that exceeds the data transfer rate. A consequence of such a transfer is that a buffer memory in the MS 270 that allows temporary storage of data being transferred from the MS 270 to the DD 280 can overflow, causing retransmissions by the BSS 250 that ultimately convey the data to the DD 280, but cause the effective downlink data rate to degrade. This invention overcomes this problem. It will be appreciated that the inventive methods described herein also apply to packet data communication systems that have other sets of coding schemes, of which the EDGE system is one example, and for which at least some mobile stations do not respond to a command to switch to particular coding schemes.

Referring to FIG. 7, a time plot shows uplink (TCP) acknowledgements when two coding schemes are used in a GPRS system, in accordance with some embodiments of the present invention. When a coding scheme is used that has an effective bit rate lower than the data transfer rate between the mobile station 270 and a peripheral device 280, and bit error rate of messages received by the MS 270 is low, acknowledgements transmitted by the MS 270 would typically look very regular, as shown by the acknowledgment tracking report 710. An example of this type of situation would be an MS 270 having a serial interface with a maximum data rate of 57.6 kbps linking the MS 270 to the peripheral device 280, while the data packet coding scheme used is CS-3, which has an effective data rate of approximately 53 kbps when all four bursts in each frame are dedicated to one MS 270 for the entire message. When a coding scheme is used that has an effective bit rate higher than the data transfer rate between the mobile station 270 and a peripheral device 280, and bit error rate of messages received by the MS 270 is low, acknowledgements transmitted by the MS 270 would look very regular for while, but then packets would begin to be dropped, as shown by the acknowledgment tracking report 705. The dropping of the packets occurs when a buffer in the MS 270 overflows as a result of packets not being moved to the peripheral device 280 quickly enough. An example of this type of situation would be an MS 270 having a serial interface with a maximum data rate of 57.6 kbps linking the MS 270 to the peripheral device 280, while the data packet coding scheme used is CS-4, which has an effective data rate of 72 kbps.

Referring to FIG. 8, a flow chart shows a method 800 of adapting coding schemes used on a downlink channel of a wireless packet data communication system, in accordance with some embodiments of the present invention. The coding schemes are adapted to achieve an optimal combination of coding schemes having an optimal data rate, according to data resource limits of a mobile station coupled to a peripheral device. The data resource limits of primary concern are the data transfer rate between the mobile station and the peripheral device, and the buffer depth of a memory that stores data in the mobile station for transfer to the peripheral device when a currently received data packet cannot be transferred to the peripheral device because earlier packets are still being transferred to the peripheral device. The method 800 may be implemented entirely within the BSC 252 by one or more processors that execute programmed instructions, or it may be distributively implemented in any combination of portions of the fixed network devices, which in this system example include the MSC 230, the GSN 240, BTS 260, and the BSS 252. In accordance with embodiments of the present invention, no changes are needed in the mobile station 270 or peripheral device 280 to implement the present invention. At step 805, a data transfer to a mobile station is started on the downlink of a radio communication system for the purpose of establishing an optimal combination of coding schemes. This may be done when the mobile station first becomes active in the radio communication system, or may be done when large amounts of data are queued up for the mobile station, or may be done when a certain amount of data is queued up for the mobile station and an optimal data rate has not been tested for a fixed time period. Other strategies could be used to determine the optimal combination of coding schemes. At step 810, an initial value of a current combination of coding schemes that will be used to transmit a set of data is selected to be the highest coding scheme supported by the mobile station, used at a highest duty cycle. In the case of a GPRS system, the highest duty cycle is four bursts (also called time slots) per frame. In a situation in which the highest coding scheme is not known to the fixed network equipment, it may be appropriate to establish the highest coding scheme supported by the mobile station before performing step 810. In subsequent loops of the method, the current combination of coding schemes may include more than one coding scheme, each having a duty cycle. It will be appreciated when the current combination of coding schemes uses, for example, two coding schemes, each at duty cycle of two time slots per frame; a current data rate that is between the effective data rates of each of the two coding schemes can be achieved.

A set of data is then transmitted on the downlink channel to the mobile station at step 815, using the current combination of coding schemes, which provide a current data rate. Monitoring is then done, at step 820, to determine whether the data transfer rate of the peripheral device has been exceeded. The results of the monitoring are used at step 825 to determine whether a search criterion has been met, and when the search criterion is met, the optimal combination of coding schemes is established as the current combination of coding, at step 840. When the search criterion is not met at step 825, a new coding scheme combination having a new data rate different from the current data rate is determined at step 830 for use in another trial (or loop of the method). The current coding scheme combination is set to the new coding scheme combination at step 835 and an additional set of data is transmitted to the mobile station at step 815 using the current coding scheme combination. Thus the steps of transmitting 815, monitoring 820, establishing 830, and setting 830 may be repeated until the search criterion has been met at step 825

In another aspect of the present invention, a buffer depth of the mobile station may be determined at step 845 after the optimal coding scheme combination has been determined at step 840. Optionally, as indicated by dotted path 846, a buffer depth determination is not used in the method. A timer is started at step 850 after the optimal coding scheme is determined at step 840 (and after the optional buffer depth determination step 845 if it is used). Until the timer times out at step 860, data messages are transferred to the mobile station using the optimal coding scheme combination, and optionally using the buffer depth. This timer may be set for several seconds, to allow for changing resource conditions (e.g., allocated mobile buffer size and changing peripheral data transfer rates. This method 800 optimizes the transfer of data from the fixed network to the peripheral device.

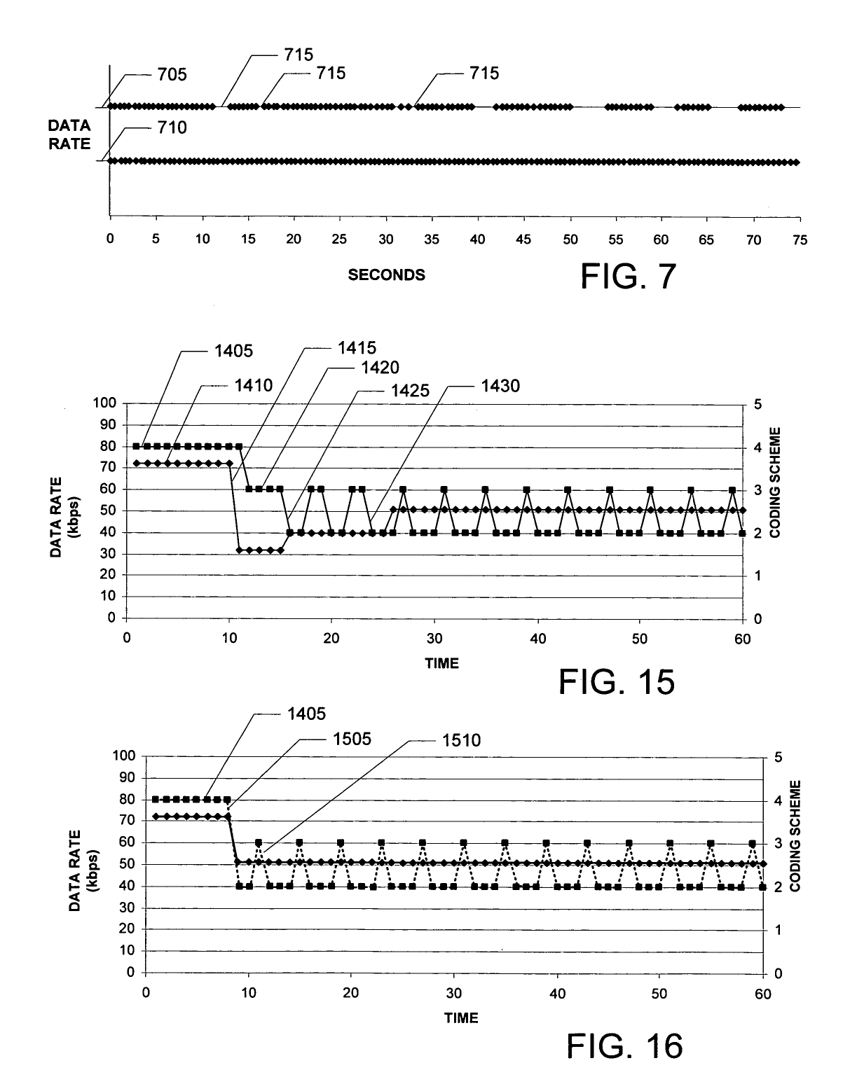

Referring to FIG. 9, a flow chart shows one method of monitoring whether the data transfer rate of the peripheral device is exceeded at step 820, in accordance with some embodiments of the present invention. At step 905, a determination is made whether the downlink and uplink channels are sufficiently error free. This can be done, for instance, by inference from a recent coding scheme negotiation between the mobile station and the fixed network having resulted in a decision that a high coding scheme, such as CS-3 or CS-4 could be used. Such a decision may be one that is made only when the downlink and uplink channels are sufficiently error free. Another technique would be to use a low coding scheme that is unlikely to cause data transfer errors due to buffer overflow, and determine channel quality by a uniformity of acknowledgements. There are other techniques, such as measuring received signal strengths at the mobile station and base transmitter station. When the downlink and uplink channels are determined not to be sufficiently error free at step 905, the method for optimizing the coding schemes may be abandoned at step 915, or (not shown in FIG. 9) a low initial coding scheme combination may be used at step 810. When the downlink and uplink channels are determined to be sufficiently error free at step 905, a determination is made at step 910 as to whether intervals of acknowledgements transmitted from the mobile station on the uplink channel in response to the set of data meet uniformity criteria. Such uniformity may require, for instance, that every downlink data packet is acknowledged, or may allow some low number of missing acknowledgements. The results of the uniformity determination are provided as inputs to step 825.

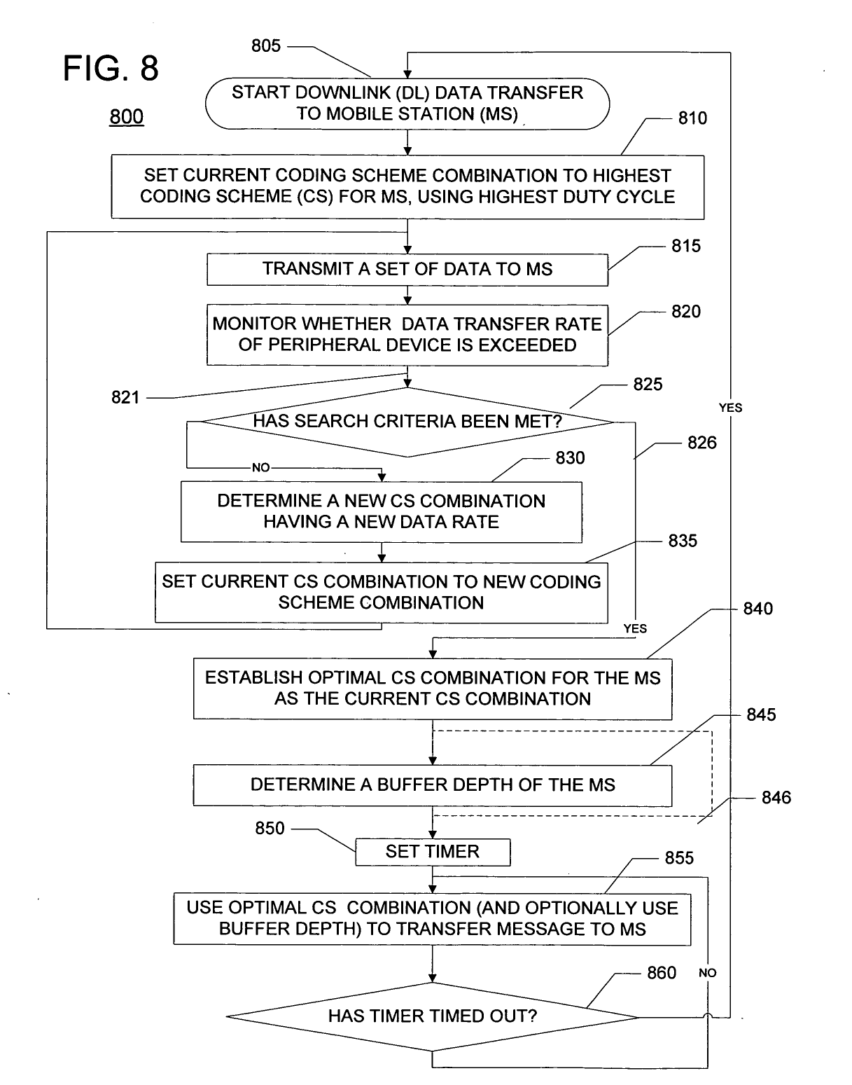

Referring to FIG. 10, a flow chart shows details of the steps 825 and 830 described with reference to FIG. 9, in accordance with some embodiments of the present invention. At step 825, a determination is made whether the data transfer rate of the peripheral has been exceeded or not, which is determined by whether the uniformity criteria are met or not at step 820. When the data transfer rate is determined to have been exceeded at step 825, a new coding scheme combination is selected that has a lower data rate than the current coding scheme combination and the method continues as described with reference to FIG. 8. The lower data rate may be different than the data rate of the current coding scheme by an amount approximately equal to a fixed amount. In one embodiment, the new coding scheme combination has a data rate that is one half of the current coding scheme combination. A duty cycle of the coding scheme combination may be chosen based on an amount and relative priority of data traffic queued for other mobile stations from the same fixed network entity. The entity could be, for example, a base transmitting station or a base station controller. For example, when there is little traffic for other mobile stations, then the optimal code scheme combination could use two lower code schemes (e.g., CS-2, CS-3) with more average time slots per frame, which might be preferable when the error rates of the downlink and uplink channels are known to have degraded. When there is other equal or higher priority data traffic queued for other mobiles, then, for example, only CS-3 could be used, but with fewer average number of time slots per frame. An optimal data scheme combination may use a varying number of time slots in frames to achieve a selected optimal (average) data rate. This varying duty cycle can achieve an accommodation of varying data traffic from other mobile stations by allowing the use of varying amounts of times slots for the other mobile stations while at the same time the duty cycle of each code scheme used by the mobile station that is communicating using an optimized code scheme is changed to maintain an optimized data rate. Thus, the term combination of coding schemes means a dynamic combination of coding scheme levels and duty cycles that achieves a selected (average) data rate.

When the data transfer rate is determined not to have been exceeded by the current data rate at step 825, then the search criterion has been met and the method continues at step 840 via path 826

Referring to FIG. 11, a flow chart shows details of the steps 825 and 830 described with reference to FIG. 9, in accordance with some binary search embodiments of the present invention. At step 1105, a first test is whether the {monitoring whether the data transfer rate of the peripheral device has been exceeded} has a result that is changed from a previous such result. When there has been a change in the result, a determination is made at step 1110 as to whether the absolute value of the difference of the current data rate and a most recent data rate is less than a precision limit. When the difference is less than the precision limit at step 1110, then the search criterion are met and the method 800 continues at step 840 (FIG. 8) via path 826. When the difference at step 1110 is not less than the precision limit, or when the result of the first test at step 11 05 is that no change has occurred, a new combination of coding schemes is determined at step 830 that has a data rate (an average data rate) that different than the current data rate by an amount that has an absolute value based on the current data rate and a most recent data rate, and a sign based on the result of the monitoring 1115. For example, the absolute value of the amount may be approximately one half of a difference of the current data rate and the most recent data rate (down to some lower limit), and the sign may correspond to whether the current data rate is greater than the data transfer rate. In this instance an initial coding scheme combination may be set to the data highest code scheme and full duty cycle, while a second initial coding scheme combination may be set to the lowest code scheme with the lowest duty cycle.

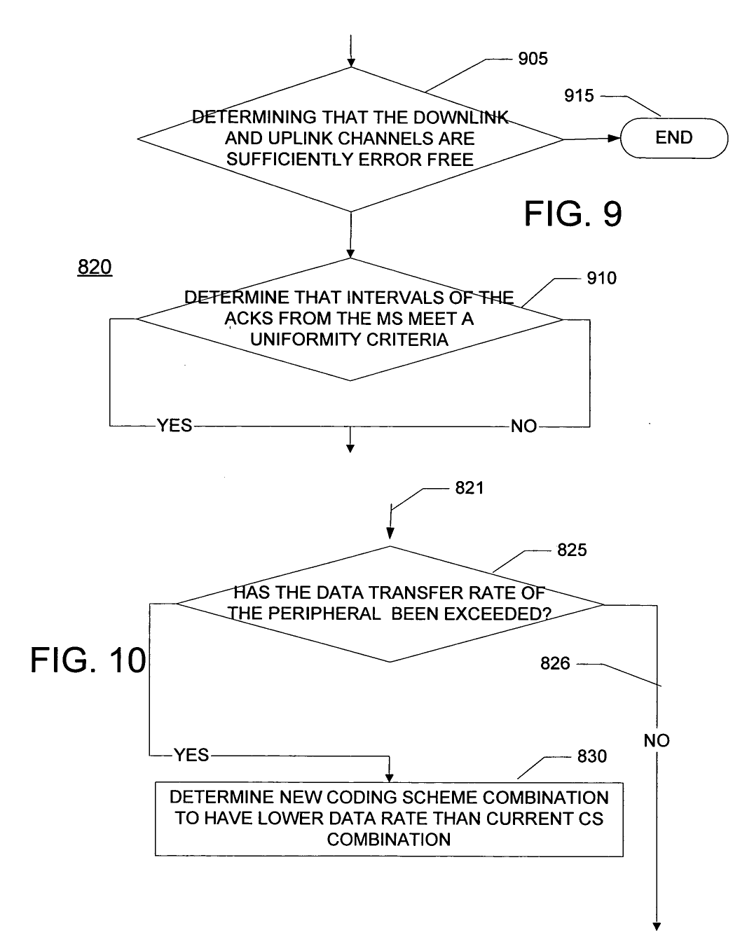

Referring to FIG. 12, a timing diagram shows one example of the use of the binary search technique described with reference to FIG. 11. In this example a mobile station coupled to a peripheral has a data transfer rate 1205 shown by the dotted line. An initial coding scheme combination is used that consists of a highest coding scheme combination, e.g., CS-4 at a 100% duty cycle, having a high data rate 1210 that becomes the current data rate. When this coding scheme combination is tested between T1 and T2, the result is that the current data rate 1210 is greater than the data transfer rate 1205. An second initial coding scheme combination is then used that consist of a lowest coding scheme combination, e.g., CS-1 at a 25% duty cycle, having a low data rate 1215 that becomes the current data rate. The current combination of coding schemes is further as a result of steps 1105 and 1110, which may be done by using two or more coding schemes and average duty cycles for each coding scheme. The average duty cycle for each coding scheme combination may be achieved by changing the duty cycle for the coding scheme from frame to frame. The adjustments result in exemplary current data rates 1210, 1215, 1220, 1225, and 1230 shown in FIG. 12. The difference between data rate 1230 and 1225 is less than the limit and a change has occurred in the determination as to whether the current data rate exceeds the data transfer rate, so the current data rate 1230 becomes the optimal data rate. This technique has been described to illustrate that a variety of search and determination techniques 825, 830 may be successfully used in accordance with the present invention.

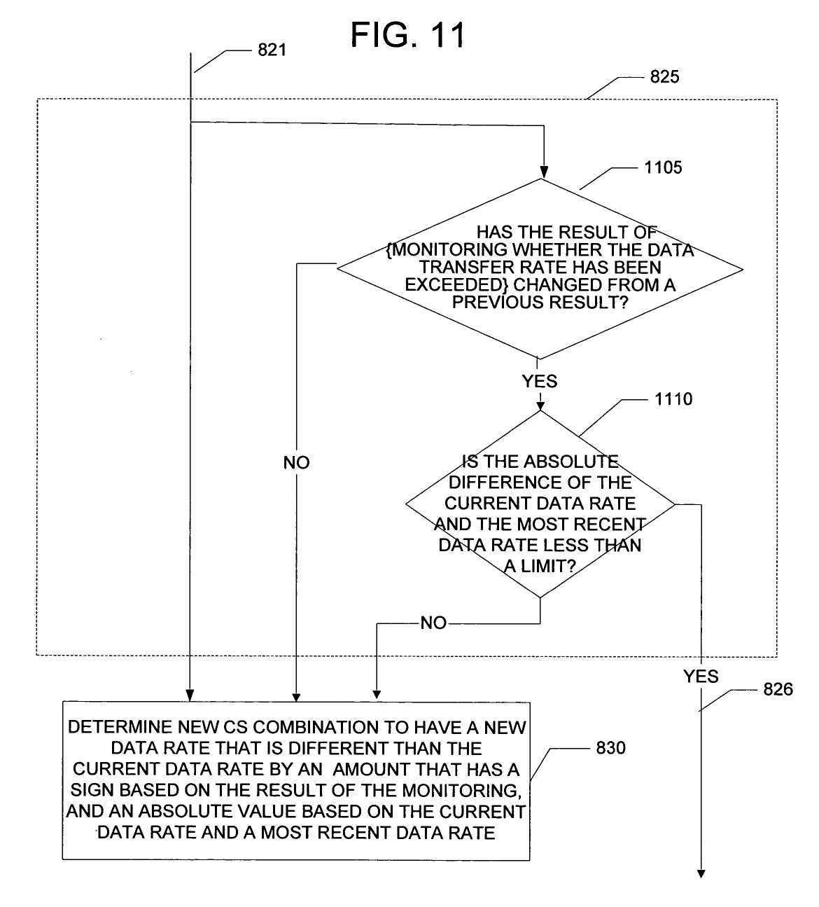

Referring to FIG. 13, a flow chart shows more detail of the step 845 of determining a buffer depth of a buffer memory of the mobile station when the search criterion has been met at step 825, in accordance with some embodiments of the present invention. A long set of data is transmitted on the downlink channel to the mobile station at step 1305 using a fast combination of coding schemes that has a fast data rate that is supported by the mobile station and is greater than a data rate of the optimal combination of coding schemes. This fast combination of coding schemes in a GPRS system may be, for example, CS-4 at 100% duty cycle; but it should be a coding scheme that the mobile station supports. (In some systems, not all mobile stations support all defined coding schemes. If a mobile station only supports coding scheme combinations [coding scheme levels and duty cycles] for which the fastest is deemed slower than any peripheral likely to be used, then the optimal coding scheme combination would be that fastest supported coding scheme combination. At step 1310, a duration from a start of the transmitting to a time at which the buffer depth of the mobile station has been exceeded is determined. The buffer depth (also called buffer capacity) is then estimated at step 1315, using the duration and a difference of the fast data rate and the data rate of another combination of coding schemes that has been tested during the method 800. One combination of coding schemes to use for the buffer capacity estimation may be the combination that had an effective coding rate closest to, but greater than, the optimal coding scheme combination. The use of this combination should provide an estimate of the buffer capacity that is less than or equal to the actual size. Another combination of coding schemes to use for the estimation is the optimal combination of coding schemes. This value may yield a value greater than the actual buffer capacity, but may be satisfactory, particularly when a more accurate method of determining the optimal combination of coding schemes is used, such as that described with reference to FIG. 11. Determining that the buffer capacity has been exceeded may comprise determining that intervals of acknowledgements transmitted from the mobile station on the uplink channel in response to the long set of data meet non-uniformity criteria, and may further comprise determining that the downlink and uplink channel are sufficiently free from errors due to path losses. Note that steps 1305 and 1310 may be performed earlier in the method 800, such as between steps

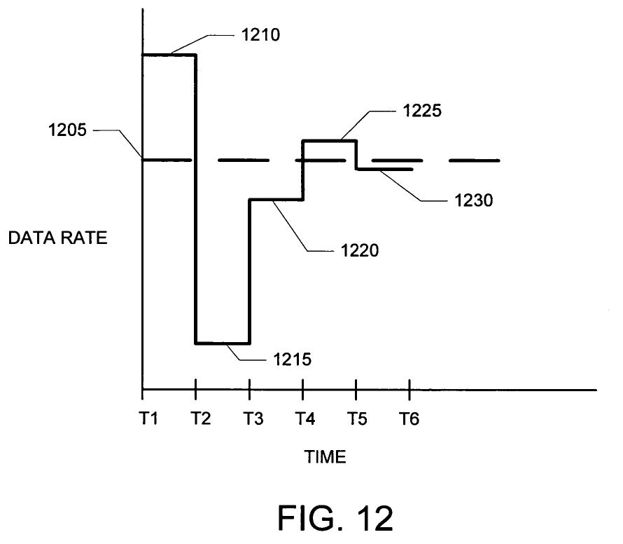

Referring to FIG. 14, a time plot shows data packets as an initial data message having a long set of data is being sent to a mobile station, in accordance with some embodiments of the present invention. Plot 1405 shows the coding scheme that is being used (values at right vertical axis), while plot 1410 shows the data rate approximately as a rolling average over four time slots (one frame). Initially, CS-4 is used at full duty cycle as the coding scheme combination. A high data rate (approximately 72 kbps) is achieved until the buffer in the mobile station fills, at which time 1415 an acknowledgment is missed. The duration from the start of the data message transmission until the missed acknowledgement is noted (FIG. 13, step 1310); at which time the coding scheme combination is changed to CS-3 at full duty cycle. More acknowledgements are missed, while an average data rate of about 32 kbps is achieved, so the coding scheme combination is changed 1425 to CS-3 at 50% duty cycle and CS-2 at 50% duty cycle, and the average data rate increases to approximately 40 kbps. No acknowledgements are missed after a predetermined time, so a new combination of coding schemes is started 1430 that comprises CS-3 at 75% duty cycle and CS-2 at 25% duty cycle. No acknowledgements are missed using this new combination of coding schemes, and the most recent increment of data rate change was less than a precision limit, so the most recent combination of coding schemes becomes the optimal combination of coding schemes. The data rate for the optimal combination of coding schemes is approximately 51 kbps. This has been determined without the mobile station informing the fixed network of the transfer data rate (which, by inference, is greater than approximately 51 kbps and less than approximately 72 kbps). It will be appreciated that for messages of sufficient length, more combinations of coding schemes could be used to establish the optimal coding scheme combination very close to the actual data transfer rate. When the actual transfer data rate has been bracketed by the data rate of the optimal coding scheme combination and a data rate of a previous coding scheme combination, the buffer size is estimated using the faster of the two data rates, which in this example would be 51 kbps.

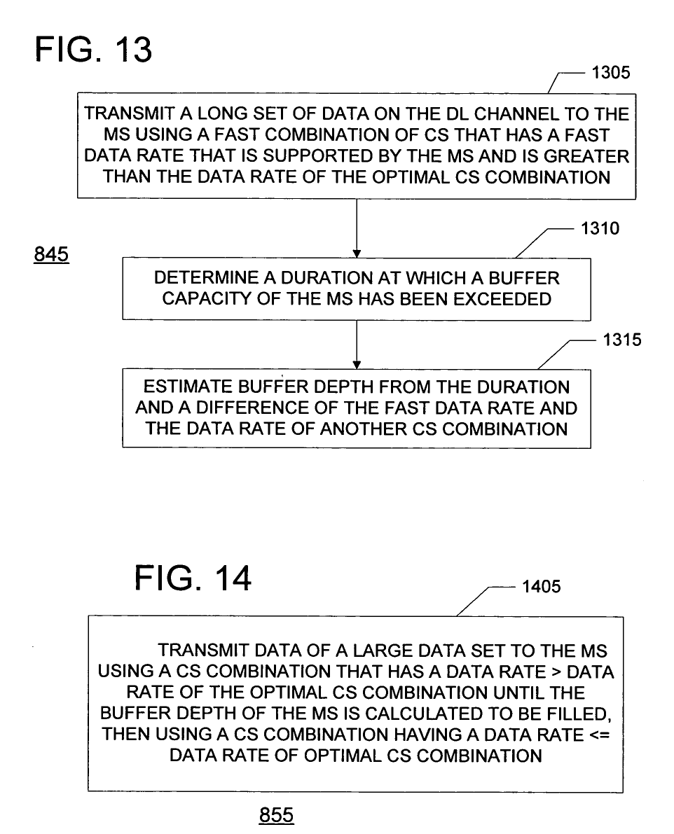

Referring to FIG. 15, a time plot shows data packets of another data message having a long set of data, in accordance with some embodiments of the present invention. The data is being sent to the same mobile station within a short period of time after the initial set of data that was sent, as described with reference to FIG. 14. (The short period of time should be less than the duration of the timer set at step 850.) This set of data can now be transmitted more efficiently by using a combination of coding schemes that has a data rate exceeding a data rate of the optimal combination of coding schemes until the time 1505 at which the estimated buffer depth of the mobile station is calculated to be filled, then using the optimal combination of coding schemes 1510 (or, a slower combination of coding schemes could be used, as appropriate to accommodate other mobile stations) for subsequent transmissions of data of the long set of data.

It will be appreciated by now that an optimal combination of coding schemes and estimated buffer capacity may be determined in a data packet radio communication system without the mobile station informing the fixed network of the transfer data rate, and these parameters may be used to improve the throughput of data messages in the radio communication system.

In the foregoing specification, the invention and its benefits and advantages have been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims.

As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

A “set” as used herein, means a non-empty set (i.e., for the sets defined herein, comprising at least one member). The term “another”, as used herein, is defined as at least a second or more. The terms “including” and/or “having”, as used herein, are defined as comprising. The term “coupled”, as used herein with reference to electro-optical technology, is defined as connected, although not necessarily directly, and not necessarily mechanically. The term “program”, as used herein, is defined as a sequence of instructions designed for execution on a computer system. A “program”, or “computer program”, may include a subroutine, a function, a procedure, an object method, an object implementation, an executable application, an applet, a servlet, a source code, an object code, a shared library/dynamic load library and/or other sequence of instructions designed for execution on a computer system. It will be further appreciated that a method or function that is typically implemented by the execution of programmed instructions by a processor may be entirely implemented without a processor and programmed instructions; an apparatus comprising a plurality of application specific logic state machines may be used instead to determine an optimal set of coding schemes.

1. A method of adapting coding schemes used on a downlink channel of a wireless packet data communication system to data resource limits of a mobile station coupled to a peripheral device, comprising:
transmitting a set of data on the downlink channel to the mobile station using a current combination of coding schemes that have a current data rate;
monitoring whether a data transfer rate of the peripheral device has been exceeded; and
establishing an optimal combination of coding schemes to be the current combination of coding schemes when a search criterion that is based on whether the data transfer rate of the peripheral device has been exceeded is met.

2. The method according to claim 1, further comprising:
determining a new combination of coding schemes that have a new data rate different than the current data rate when the search criterion has not been met;
setting the new combination of coding schemes to be the current combination of coding schemes; and
repeating the transmitting, monitoring, determining, and setting until the search criterion has been met.

3. The method according to claim 1, wherein an initial value of the current combination of coding schemes consists of a highest coding scheme supported by the mobile station, transmitted using a highest duty cycle.

4. The method according to claim 1, wherein the search criterion is that the data transfer rate of the peripheral device has not been exceeded, and the establishing comprises determining the new combination of coding schemes to have a new data rate that is less than the current data rate.

5. The method according to claim 4, wherein the establishing comprises determining the new combination of coding schemes to have a new data rate that is one half of the current data rate.

6. The method according to claim 1, wherein the search criterion is
a result of monitoring whether the data transfer rate of the peripheral device has been exceeded is changed from a previous result, and
an absolute value of a difference of the current data rate and a most recent data rate is less than a precision limit, and
wherein the establishing comprises
establishing the new combination of coding schemes to have a new data rate that is different than the current data rate by an amount that has a sign based on the result of monitoring, and an absolute value based on the current data rate and the most recent data rate.

7. The method according to claim 1, wherein the optimal combination of coding schemes includes coding schemes that vary from frame to frame in one of coding scheme level and duty cycle, and provide a common average data rate.

8. The method according to claim 7, wherein the optimal combination of coding schemes is varied to allow frame sharing with other mobile stations.

9. The method according to claim 1, wherein the monitoring of whether a data transfer rate of the peripheral device has been exceeded comprises determining whether intervals of acknowledgements transmitted from the mobile station on an uplink channel in response to the set of data meet uniformity criteria.

10. The method according to claim 9, wherein the monitoring further comprises determining that the downlink and uplink channels are sufficiently error free.

11. The method according to claim 1, further comprising determining a buffer depth of the mobile station when the search criterion has been met.

12. The method according to claim 11, wherein the determining of the buffer depth comprises:
transmitting a long set of data on the downlink channel to the mobile station using a fast combination of coding schemes that has a fast data rate that is supported by the mobile station and is greater than a data rate of the optimal combination of coding schemes;
determining a duration from a start of the transmitting to a time at which a buffer depth of the mobile station has been exceeded; and
estimating the buffer depth of the mobile station,based on the duration and a difference of the fast data rate and a data rate of an other combination of coding schemes.

13. The method according to claim 12, wherein the other combination of coding schemes is the optimal combination of coding schemes.

14. The method according to claim 12, wherein determining that the buffer depth has been exceeded comprises determining that intervals of acknowledgements transmitted from the mobile station on an uplink channel in response to the long set of data meet non-uniformity criteria.

15. The method according to claim 14, wherein determining that the buffer depth has been exceeded further comprises determining that the downlink and uplink channels are sufficiently free from errors.

16. The method according to claim 1, wherein the wireless packet data communication system is one of a General Packet Radio Service, an Enhanced General Packet Radio Service, and a Universal Mobile Telecommunications System.

17. The method according to claim 1, further comprising sending a data message to the mobile station using the optimal combination of coding schemes.

18. The method according to claim 1, further comprising transmitting data of a long set of data to the mobile station using a combination of coding schemes that has a data rate exceeding a data rate of the optimal combination of coding schemes until the buffer depth of the mobile station is calculated to be filled, then using a combination of coding schemes having a data rate less than or equal to the data rate of the optimal combination of coding schemes for subsequent transmissions of data of the long set of data.

19. A method of adapting a coding scheme used on a downlink channel of a wireless packet data communication system to data resource limits of a mobile station coupled to a peripheral device, comprising:
establishing an optimal combination of coding schemes that is less than a data transfer rate of the peripheral device; and
determining a buffer depth of the mobile station after the optimal combination of coding schemes has been established.

20. The method according to claim 19, further comprising transmitting data of a long set of data to the mobile station using a combination of coding schemes that has a data rate exceeding a data rate of the optimal combination of coding schemes until the buffer depth of the mobile station is calculated to be filled, then using a combination of coding schemes having a data rate less than or equal to the data rate of the optimal combination of coding schemes for subsequent transmissions of data of the long set of data.

21. A base station controller, comprising:
a function that transmits a set of data on a downlink channel to a mobile station using a current combination of coding schemes that have a current data rate;
a function that monitors whether a data transfer rate of a peripheral device has been exceeded; and
a function that establishes an optimal combination of coding schemes to be the current combination of coding schemes when a search criterion that is based on whether the data transfer rate of the peripheral device has been exceeded is met.

22. The station controller according to claim 21, wherein the function of monitoring of whether a data transfer rate of the peripheral device has been exceeded comprises a function of determining whether intervals of acknowledgements transmitted from the mobile station on an uplink channel in response to the set of data meet uniformity criteria.

23. The station controller according to claim 22, wherein the function of monitoring further comprises a function of determining that the downlink and uplink channels are sufficiently error free.

24. The method according to claim 21, wherein a function of determining of a buffer depth comprises:
a function of transmitting a long set of data on the downlink channel to the mobile station using a fast combination of coding schemes that has a fast data rate that is supported by the mobile station and is greater than a data rate of the optimal combination of coding schemes;
a function of determining a duration from a start of the transmitting to a time at which a buffer depth of the mobile station has been exceeded; and
a function of estimating the buffer depth of the mobile station, based on the duration and a difference of the fast data rate and a data rate of another combination of coding schemes.

25. A base station controller, comprising:
a function that determines an optimal combination of coding schemes that has an optimal data rate less then or equal to a transfer data rate of a peripheral to a mobile station;
a function that determines a buffer depth of the mobile station; and
a function that transmits data of a long set of data to the mobile station using a combination of coding schemes that has a data rate exceeding the optimal data rate until the buffer depth of the mobile station is calculated to be filled, then uses a combination of coding schemes having a data rate less than or equal to the optimal data rate for subsequent transmissions of data of the long set of data.
